(19) United States
(12) Patent Application Publication
(10) Pub. No.: US 2006/0223942 A1
(43) Pub. Date: Oct. 5, 2006

(54) Stretch wrap films

(75) Inventor: Gianni Perdomi, Ferrara (IT)

Correspondence Address: BASELL USA INC., INTELLECTUAL PROPERTY, 912 APPLETON ROAD, ELKTON, MD, 21921, US

(73) Assignee: BASELL POLIOLEFINE ITALIA S.r.l., Milano (IT)

(21) Appl. No.: 10/557,297

(22) PCT Filed: May 19, 2004
(86) PCT No.: PCT/EP04/05564

§ 371 Date: Nov. 18, 2005

Related U.S. Application Data
(60) Provisional application No. 60/474,419, filed on May 30, 2003.

(30) Foreign Application Priority Data
May 21, 2003 (EP) 03011529.9

(51) Int. Cl. C08L 23/04

(52) U.S. Cl. 525/240

(57) ABSTRACT

A stretchable wrap film comprising a polymer blend comprising (percent by weight): I) 50 to 90% of an ethylene polymer composition comprising a recurring unit derived from an ester selected from (1) ethylenically unsaturated organic monomer of esters of unsaturated C₃-C₂₀ monocarboxylic acids and C₁, to C₂₄ monovalent aliphatic or alicyclic alcohols, and (2) vinyl esters of saturated C₂-C₁₈ carboxylic acids, wherein the ester content ranging from 2.5 to 8 wt % based on the total weight of the final ethylene polymer composition; the ethylene polymer composition having a density ranging from 0.920 to 0.94 g/mL; and II) 10 to 50% of an ethylene-based polymer component having a density ranging from 0.9 to 0.930 g/mL and a melt flow rate up to 4 g/10 min. The stretchable wrap film has a ratio between the value of MD tear resistance and the value of TD tear resistance over 0.3 and a value of MD tensile strength at 30% ranging between 6.5 to 15 N. The stretchable film is suited for use as stretch, cling wraps in various bundling, packaging and wrapping operations.

The present invention relates to a container packaging made of stretchable wrap films that have good mechanical and chemical-physical properties. More particularly, it relates to stretchable cold-shrinkable wrap films made of polyolefin materials comprising a blend of low density ethylene polymers and minor amounts of linear polyethylene.

Stretchable films that self-seal when portions are overlapped are known as “cling” films. Stretch, cling films, which are most often multilayer films, have found utility in a wide variety of applications where it is desirable to securely hold and/or wrap an article or group of articles. The stretchable films are suited for use as stretch, cling wraps in various bundling, packaging and wrapping operations, such as stretch wrapping, stretch bundling and tension winding, to wrap or hold a small article or a big article.

One application of particular, but not limiting, interest to the present invention is in the bundling of an article or a plurality of identical or different articles of widely varying types to form a unitary pack. An important subset of the said bundling applications is in the containment and unitizing of pallet loads.

Unitary packs allow articles to be assembled in stable units and in uniform shapes, thereby enabling their transportation to be rationalized and consequently made more economical but also preserve article cleanliness. The need of a unitary pack is therefore especially for shipping, transporting and storage and accounting purposes, for example from the manufacturer to a retail outlet.

Nowadays, for wrapping and bundling articles, thermoplastic films have long been used in lieu of the conventional cardboard boxes. The use of stretchable films in the field of bundling of industrial and retail goods constitutes an application of significant commercial importance.

All thermoplastic polymers or copolymers, in the form of stretchable films, having a sufficient tear resistance can be employed for packaging and bundling applications. Nevertheless, the polyolefins and, more particularly, polyethylene, such as linear low-density polyethylene (LLDPE), or polypropylene, alone or even blended with copolymers of ethylene and propylene and an olefinically unsaturated monomer such as vinyl acetate, are those that are most frequently used industrially. The conventional films are suited for wrapping groups of articles, the final wrapping over the groups of articles usually consists of a film/sheet of heat-shrink material.

Bundling applications are techniques which entail enveloping the totality of the articles to be packaged with a shrinkable wrapping cling film that is stretched tightly around an article or plurality of articles. In such applications, it is essential that the films have cling properties in the stretched state. The film is then shrunk by exposing the assembly to sufficient heat to cause shrinking of film and intimate contact between the film and article(s). The heat that induces shrinkage can be provided by conventional heat sources, such as heated air, infrared radiation, hot water, hot oil combustion flames, or the like. For example, the entire assembly is transferred through an oven at a temperature that permits the thermoplastic resin constituting the film to soften, thus relieving internal stresses. Upon exiting the oven, rapid cooling ensures that the film shrinks tightly and sealedly around the goods contained therein. Thus, a highly homogeneous bundle or unitary pack is produced in which the film functions as a skin in tight contact with the surface of the packaged goods.

The high cost of the heat shrink film, however, makes the wrapping very expensive, not to mention that in some cases and for some types of products, the wrapping lines may, also, be very expensive for the manufacturer because they have numerous operating units, such as product collating units (especially in the case of continuous lines), and film feed and heating units, all of which require a high number of control devices and accessory parts. Another limiting factor on the use of heat shrink films and lines of this kind is the fact that some products cannot be heated beyond certain limits, which means that heat shrink wrapping solutions are not feasible.

As mentioned above, prior art films comprising a blend of linear low-density polyethylene (LLDPE) and olefinically unsaturated monomer-ethylene copolymers are already known also for use in bundling and packaging in general.

For example, European patent application 377,121 discloses heat-shrinkage films having a layer made from a blend of 10-50 wt % of low density polyethylene (LDPE) and 50-90 wt % of ethylene-1-olefin copolymer having low density. However, it is well known from industry that such type of blends has improved processability and optical properties but has unbalanced mechanical properties.

U.S. Pat. No. 4,551,380 discloses heat-shrinkable multi-layer films wherein the surface layer is a blend of linear low density polyethylene, linear medium density polyethylene and ethylene-vinyl acetate copolymer.

U.S. Pat. No. 5,399,426 discloses a stretch wrap film having at least a core layer made from a polymer blend that consists of about 3 to about 16.7 wt % of branched polymer, such as ethylene-vinyl acetate copolymers, and about 83.3 to about 97 wt % of linear polyethylene, such as linear low density polyethylene (LLDPE) and ultra linear low density polyethylene (ULDPE). The mono- or multilayer film is produced by known blown film and cast film processes.

The latter films are not suitable to use in bundling applications due to their poor elastic or unbalanced holding force retention that influences toughness of packaged items.

Hence, there is a commercial need for a stretchable wrap film that does not require heat to be shrunk and having the characteristics required for bundling.

The Applicant has now found a stretchable cold-shrinkable wrap film that exhibits mechanical, optical and chemical-physical properties that make the film suitable for use in bundling applications, of an article or a plurality of articles to provide a unitized packaged unit.

Thanks to its improved mechanical and physical properties, the films of the present invention are particularly useful to the bundling of groups of relatively large and, above all, quite heavy products, such as large rolls of carpet, fabric, bottles or the like. In particular, by bundling technique the manufacture of a secondary container packaging material for a plurality of articles such as canned food, bottles and cans is also carried out. The term “secondary container packaging” as generally understood in the industry and as used herein refers to packaging used in conjunction with primary containers, such as cans or bottles, which contain the ultimate product, such as food, beer, water or other beverages. Secondary container packaging includes container wraps which surround and support the primary containers, and an upwardly extending handle.

The present films have a good balance of mechanical properties, in particular a very high degree of stretchability of the films combines with the good elastic recovery and high residual strength. The invented films can stretch to wrap the goods but cannot permanently lose their shape. The elastic recovery allows the films to shrink and the high residual strength keeps the goods pressed.

The present films also show good holding force retention after packaging items as well as good impact resistance but also transparency among the optical properties.

The film of the present invention has also good heat-sealability that is required due to the type of packaging technique that can be used.

The film of the present invention has a quite balanced ratio between machine direction tear resistance and transverse direction tear resistance,

The film of the present invention offers the considerable advantage that now it can be manufactured a secondary container packing having a handle structure that is formed as integral part of the secondary container packing. Hence, the handle structure is made up of the same type of film as the remaining part of the container packaging. Therefore, there is no need of applying a separate handle to the container packaging, thus reducing the overall cost of such a packaging. In addition, the packaging can entirely be made of polyolefin materials and thus recycling of the whole packaging is easier because it is no longer necessary to remove the handle from the film.

Another advantage is provided with the film of the present invention as a result of the superior property balance, the film can have a significantly lower thickness than that of the currently used films in the same field of packaging. This allows both cost savings and reduction of the environmental impact.

The film of the present invention exhibits another great advantage for the industry because heat is not required to shrink the film around item(s). In fact, after the film is stretched to wrap the item(s), the film shrinks around the item(s) without subjecting the film to elevated temperatures. Even room temperature allows the film to shrink around the product to produce a tight wrapping that closely conforms to the contour of the item(s). This allows to make time and energy savings.

Therefore, the present invention provides a stretchable wrap film comprising an olefin polymer blend comprising (percent by weight):
I) 50 to 90%, preferably higher than 50 to 90%, more preferably 65 to 80%, of an ethylene polymer composition comprising a recurring unit derived from an ester selected from (1) ethylenically unsaturated organic esters of unsaturated C₃-C₂₀ monocarboxylic acids and C₁ to C₂₄ monovalent aliphatic or alicyclic alcohols, and (2) vinyl esters of saturated C₂-C₁₈ carboxylic acids, wherein the ester content ranging from 2.5 to 8 wt %, preferably 3 to 6.5 wt %, based on the total weight of the final ethylene polymer composition; the ethylene polymer composition having a density ranging from 0.92 to 0.94 g/mL, preferably 0.92 to less than 0.94, g/mL, more preferably 0.92-0.935 g/mL; and
II) 10 to 50%, preferably 10 to less than 50%, more preferably 20 to 35%, of an ethylene-based polymer component having a density ranging from 0.9 to 0.930 g/mL, preferably 0.910 to 0.925 g/mL and a melt flow rate up to 4 g/10 min, preferably from 0.5 to 2 g/10 min; the said component being selected from:
   i) a linear polyethylene (i) consisting of ethylene and 0.5 to 20% by mole of a CH₂═CHR α-olefin, where R is a hydrocarbon radical having 2-8 carbon atoms; and
   ii) a polymer blend (ii) comprising (a) 80-100 parts by weight of a random interpolymer of ethylene with at least one CH₂═CHR α-olefins, where R is a hydrocarbon radical having 1-10 carbon atoms, the said polymer containing up to 20 mol % of CH₂═CHR α-olefin and having a density between 0.88 and 0.945 g/mL; and (b) from 5 to 30 parts by weight of a random interpolymer of propylene with at least one CH₂═CHR α-olefin, where R is a hydrocarbon radical having from 2 to 10 carbon atoms, and possibly with ethylene, said interpolymer (b) containing from 60 to 98% by weight of units derived from propylene, from 2 to 40% by weight of recurring units derived from the CH₂═CHR α-olefin, and from 0 to 10% by weight of recurring units derived from ethylene, and having a xylene-insoluble fraction a room temperature greater than 70%.

The stretchable wrap film according to the present invention has a ratio between the value of MD tear resistance and the value of TD tear resistance over 0.3 and a value of MD tensile strength at 30% ranging between 6.5 to 15 N.

The film of the present invention has an improved balance of tear resistance measured in machine direction (MD) and transverse direction (TD). It means that the said two values of tear resistance are quite closer to each other.

The preferred film has a ratio between the value of MD tear resistance and the value of TD tear resistance over 0.35, in particular from 0.35 to 1.5.

Preferably the film has a value of MD tensile strength at 30% ranging between 7 to 12 N, more preferably 7.5 to 12 N.

The preferred film has a value of MD normalised residual strength at 30% ranging from 6 to 9.5 cN/μm, preferably from 6.2 to 9.5 cN/μm.

The film advantageously has a ratio between the value of MD residual strength at 30% and MD tensile strength at 30% over 0.46.

The preferred film of the present invention has a value of haze less than 16%.

The said mechanical and optical properties are determined as explained hereinbelow.

As used herein, the phrase “normalised residual strength” is the residual strength divided by the thickness of the film; the abbreviation “MD”means “machine direction”, and refers to a direction “along the length” of the film, i.e., in the direction of the film as the film is formed during extrusion and/or coating; the abbreviation “ID” means “transverse direction”, and refers to a direction across the film, perpendicular to the machine or longitudinal direction.

Preferably, ethylene polymer composition (I) consist of an interpolymer of ethylene with at least one comonomer selected from above-mentioned esters (1) and (2), wherein the comonomer content is within the 2-8 wt % range.

The term “interpolymer” as used herein refers to polymers prepared by the polymerization of at least two different types of monomers. The generic term “interpolymer” thus includes the term “copolymers” (which is usually employed to refer to polymers prepared from two different monomers) as well as the term “terpolymers” (which is usually employed to refer to polymers prepared from three different types of monomers, e.g., an ethylene/butene/hexene polymer).

Alternatively, ethylene polymer composition (I) can be a blend comprising (a) an ethylene homopolymer or interpolymer of ethylene with at least one of above-mentioned esters (1) and (2) wherein the esters content is in an amount from 2 to less than 8 wt % and (b) an interpolymer of ethylene with at least one of above-mentioned esters (1) and (2). In interpolymer (b) the content of the ester(s) can be higher than 8 wt %, provided that in the blend the ester content is in the range from 2 to 8 wt %.

In said blend ethylene homopolymer (a) is preferably a low density ethylene homopolymer (which is known as LDPE), which typically has melt flow rate ranging from 0.1 to 20 g/10 min and a density value of 0.915-0.932 g/mL. LDPE is produced according to known polymerisation method with a free radical initiator, such as peroxide and oxygen. It is generally produced by either a tubular or a stirred autoclave reactor.

In such a blend ethylene interpolymer (b) can have a density value higher than 0.940 g/ml.

As specific examples of the comonomers copolymerized with the ethylene monomer to produce ethylene polymer composition (I), there can be mentioned unsaturated carboxylic acid esters represented by acrylates and methacrylates, which include acrylates and methacrylates having a linear or branched alkyl group with 1 to about 24 carbon atoms, such as methyl acrylate, ethyl acrylate, propyl acrylate, butyl acrylate, t-butyl acrylate, isobutyl acrylate, pentyl acrylate, isononyl acrylate, hexyl acrylate, 2-methylpentyl acrylate, octyl acrylate, 2-ethylhexyl acrylate, dodecyl acrylate, methyl methacrylate and ethyl methacrylate; lauryl(meth)acrylate and cyclohexyl(meth)acrylate.

In branched ethylene polymer composition (I) having low density preferred esters which can be copolymerized with ethylene include methyl acrylate copolymers (EMA), ethyl acrylate (EEA copolymers), butyl acrylate (EBA copolymers) and vinyl acetate (EVA copolymers). EMA copolymers, EBA copolymers and EVA copolymers are the most preferred copolymers.

Ethylene polymers (II) are inclusive of diverse groups of ethylene polymers having low density. More specifically, the term “linear polyethylene” used herein encompasses both heterogeneous materials as linear low density polyethylene (LLDPE), very low and ultra low density polyethylene (VLDPE and ULDPE) as well as homogeneous polymers. Said homogenous polymers also known as plastomers are thermoplastic homopolymers of ethylene and interpolymers of ethylene, with one or more α-olefins having 2-10 C-atoms, which are to be prepared by means of metallocene catalysts and other single-site catalysts. As a rule, the proportion of comonomer ranges between 0 and 50 wt. %, preferably between 5 and 35 wt. %. Said homogeneous polymers usually has a density between 0.90-0.930 g/mL and a melt flow rate value of 0.8-2.0 g/10min at 2.16 kg loading and 190° C. The homogeneous polymers are different from the polyethylenes prepared by means of Ziegler-Natta catalysts, for example, in that they have a narrow molecular weight distribution, which in terms of \overline{M}_{w}/\overline{M}ₙ values usually ranges between 1.5 and 3, and a limited degree of long chain branching. As a rule, the number of long chains amounts to maximally 3 per 1000 C-atoms.

Suitable homogeneous polymers are produced on a commercial scale, for example by Exxon Chemical Company and DEX-Plastomers under the brand name Exact and by Dow Chemical Company, which commercializes them with the trademark Engage, Affinity and Elite, and by Mitsui Petrochemical Corporation, which commercialized them with the trademark Tafmer.

In ethylene polymer composition (I) the ester content is typically 3 to less than 5 wt % when ethylene-based polymer component (II) is a homogeneous polymers.

Ethylene polymers (II) as interpolymers are obtained by copolymerizing ethylene with the above CH₂═CHR α-olefins where R is a linear or branched hydrocarbon radical with from 2 to 8 carbon atoms; the olefin is preferably selected from 1-butene, 1-hexene, 1-octene and 4-methyl-1-pentene. The most preferable comonomers in the ethylene copolymer are 1-butene, 1-hexene and 1-octene.

Linear polyethylene (II) used in the present invention is prepared according to known ways of polymerization involving the use of coordination catalysts of the “Ziegler-Natta” or “Philips” type. For example, it is prepared by copolymerization of ethylene with a C₄-C₁₀-α-olefin in the presence of a Ziegler-Natta type catalyst obtained by the reaction of an organometallic compound of a metal from groups 2 and 3 of the Periodic Table with a catalytic component comprising a transition metal belonging to groups 4 to 6 of the Periodic Table. Preferably the transition metal compound is supported on a solid carrier comprising magnesium halide in active form. Examples of catalysts usable in the preparation of the copolymer are described in U.S. Pat. Nos. 4,218,339 and 4,472,520. The catalyst may also be prepared according to the methods described in the U.S. Pat. Nos. 4,748,221 and 4,803,251. Particularly preferred are the catalysts comprising components having regular morphology, for example spherical. Examples of such catalysts are described in the European patent applications 395083, 553805 and 553806.

The above polymer blend (ii) is described in international patent application WO 95/20009. The propylene polymer in blend (ii) may be, for example, a copolymer of propylene with ethylene or a copolymer of propylene with butene-1. It is preferably a terpolymer of propylene with ethylene and a C₄-C₁₀-α-olefin. In such a case, the propylene content is from 85 to 96 wt %, the ethylene content is from 2 to 8 wt % and the C₄-C₁₀-α-olefin content is from 2 to 7 wt %. In polymer blend (ii) component (a) is preferably a copolymer of ethylene with 1-butene and component (b) is a terpolymer of propylene with ethylene and 1-butene.

The high insolubility in xylene of the propylene interpolymer (b) is indicative of a stereoregular structure of the propylene recurring units and of homogenous distribution of the comonomer(s) in the copolymer chain. The insolubility in xylene, determined as described hereinbelow, is preferably greater than 75 wt %, more preferably greater than 85 wt %.

The heat of fusion of the propylene interpolymer (b) is generally greater than 50 J/g, preferably greater than 60 J/g, more preferably greater than 70 J/g.

The melting temperature of the propylene interpolymer (b) is below 140° C. and preferably from 120° to 140° C.

The crystalline index of the propylene interpolymer (b) is generally greater than 50%.

The MFR value, which is determined as described hereinbelow, of the propylene interpolymer (b) is generally from 2 to 30 g/10 min.

The propylene interpolymer (b) can conveniently be prepared using a highly stereospecific catalyst, for example, of the type described in patent application EP 395 083.

Polymer blend (ii) can be obtained by firstly blending the components (a) and (b) in the solid state and then being fed into the extruder wherein the two components are mixed in the molten state, for example in a mixer with high mixing efficiency.

According to a preferred method, polymer blend (ii) is prepared directly by polymerization process in at least two reactors in series which, working in any order and using the same catalyst in the various reactors, ethylene polymer (a) is prepared in one reactor and the propylene polymer (b) is produced in the other. The polymerization is conveniently carried out in the gas phase using fluidized-bed reactors. Examples of polymers prepared according to the said method are described in patent applications WO 93/03078 and WO 95/20009. A suitable catalyst is obtained from the reaction of:
A) a solid catalytic component comprising a titanium component containing at least a titanium halogen bond supported on a magnesium halide in active form and optionally an electron-donor compound;
B) an Al-alkyl compound; and, optionally,
C) an electron-donor compound.

The polymer blend according to the present invention is formed by any convenient method, including dry blending the individual components and subsequently melt-mixing, either directly in the extruder used to make the film, or by pre-melt mixing in separate extruder before making the film.

Obviously, in accordance with what is known by a person skilled in the art, further additives (such as stabilizers, antioxidant, antiblocking, slip agents, colours, etc.) and fillers than are capable of imparting specific properties to the film of the present invention may be added to the said polymer blend.

The film formed from the polymer blend described herein is made using the known film manufacturing method and equipment for blown films and cast films. For example, the blend may be cast into film with a flat die or blown into film with a tubular die.

The film of the present invention may be monolayer or multilayer film. However, for coextruded multilayer film structures (e.g., 3-layer film structures) at least one skin layer should be made from the polymer blend described herein, of course it can also be used as a core layer of the structure. Generally, the polymer blend described herein comprises at least 50% by weight of the total multilayer film structure. Preferably, the polymer blend disclosed herein is used as the core layer. In such a film, the skin layers can comprise other polyethylene types from high to low density as well as polypropylene types, or blends of them, in order to impart particular properties at inner or outer face of the film.

A particular aspect of this invention can involve a multilayer film where each layer of film consists of the same claimed polymer composition which, however, contains different additives, stabilizers, fillers and so on.

The thickness of the film of the present invention may vary, but is typically from 25 to 100 μm, preferably from 40 to 70 μm. The film typically has a weight of from 25 to 90 g/m². For the three layer film structures same final thickness and weight are useful, but each layer distribution may vary from 5 to 50% of the total film thickness, and a number of layers are minimum 2 to 7, preferably 3 to 5.

The cast or blown film according to the present invention is particularly suitable to be used for overlapping a plurality of items by the method described in Italian patent No. 1285827, for example. In the case of blown film, the process is carried out by using a blow-up ratio (known as B.U.R.) higher than 1.8. According to the said method the film is formed into a tubular shape by sealing the two ends of the film having a convenient length each other. Also, already formed tubular films are used then cut into the desired length, suitable for packaging step. Then, the film is stretched with an appropriate mechanical device and a plurality of items is inserted inside the stretched tubular film. Finally, the mechanical device leaves again the film that closes the plurality of items thanks to elastic recovery of the film.

The films according to the present invention can be printable after corona treatment.

The following examples are given to illustrate and not to limit the present invention.

The data relating to the polymer blends and the films of the examples are determined by way of the methods reported below.
MFR: Measured according to ISO method 1133 (190° C., 2.16 kg).
Density: Measured according to ASTM method D-792.
Comonomer content: Determined by IR spectroscopy, unless specified.
Fractions soluble and insoluble in xylene at 25° C.: 2.5 g of polymer are dissolved in 250 ml of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble and insoluble at room temperature (25° C.).
Tear resistance: Measured using an Elmendorf tear tester according to ASTM method D 1922, determined both in machine direction and transversal direction.
2% secant tensile modulus: Determined according to ASTM method D 822.
Tensile strength and residual strength: Determined according the MA 17301 internal method available upon request. A 12.7 mm×100 mm film specimen is used.
The test is carried out on a film specimen cut from a film. The film has previously been kept at 23° C., 50% is the relative humidity, for at least 24 hours but not over 48 hours.
The film specimen is placed in an Instron-type dynamometer working at a tensile rate of 50 mm/min. The film is stressed up to a deformation of 30%. The strength is measured when the deformation of 30% is reached (maximum strength) and after 240 minutes from the deformation of 30% is reached (strength 240). The residual strength ratio is defined as the ratio between residual strength at strength 240 and maximum strength.
Dart: Determined according to ASTM method D 1709A.
Haze: Determined according to ASTM method D 1003.
Packaging test: the films prepared as described in the examples are used to wrap 6 bottles. The bottles are packed by using a packaging machine described in Italian patent No. 1285827, the machine also seals the two endings of the films.
The evaluated properties are resistance of the sealed film portion and quality of packaging.
The quality of sealing is determined by evaluating resistance at yielding or breakage of sealing portion after the sealing.
The quality of packaging is determined by evaluating toughness of the packaged items after 1 minute.

### POLYMERS USED IN THE EXAMPLES AND COMPARATIVE EXAMPLES

Ethylene-butyl acrylate copolymer, EBA copolymer (1): the content of recurring units derived from butyl acrylate is 4.5 wt %, the MFR value is 0.25 g/10 min and the density is 0.922 g/mL;
Ethylene-butyl acrylate copolymer, EBA copolymer (2): the content of recurring units derived from butyl acrylate is 6.5 wt %, the MFR value is 0.25 g/10 min and the density is 0.923g/mL;
Ethylene-butyl acrylate copolymer, EBA copolymer (3): the content of recurring units derived from butyl acrylate is 3.0 wt %, the MFR value is 0.5 g/10 min and the density is 0.923 g/mL;
Ethylene-vinyl acetate copolymer blend, EVA copolymer (1): it is a blend made from 44 wt % of an ethylene-vinyl acetate copolymer having a content of recurring units derived from vinyl acetate of 14 wt %, the MFR value is 0.3 g/10 min and the density is 0.938 g/mL and 56 wt % of the low density ethylene homopolymer (LDPE) described hereinbelow; the density of the blend is 0.930 g/mL;
Ethylene-vinyl acetate copolymer, EVA copolymer (2): the content of recurring, units derived from vinyl acetate is 5.0 wt %, the MFR value is 0.5 g/10 min and the density is 0.928 g/mL;
Ethylene-methyl acrylate copolymer blend, EMA copolymer: it is a blend made from 25.3 wt % of ethylene-methyl acrylate copolymer having a content of recurring units derived from methyl acrylate of 23.9 wt % (determined by ¹³C-NMR spectroscopy), the;MFR value is 2.4 g/10 min and the density is 0.946 g/mL and 74.7 wt % of the low density ethylene homopolymer (LDPE) described hereinbelow, the density of the blend is 0.928 g/mL;
Ethylene-ethyl acrylate copolymer blend, EEA copolymer: it is a blend made from 38.7 wt % of ethylene-ethyl acrylate copolymer having a content of recurring units derived from ethyl acrylate of 16.5 wt % (determined by ¹³C-NMR spectroscopy), the MFR value is 1.1 g/10 min and the density is 0.929 g/mL and 61.3 wt % of the low density ethylene homopolymer (LDPE) described hereinbelow, the density of the blend is 0.925 g/mL;
Low density polyethylene, LDPE: the ethylene homopolymer has an MFR value of 0.3 g/10 min and density of 0.923 g/mL;
Linear low density ethylene-octene-1 copolymer, LLDPE (1): the content of recurring units derived from octene-1 is 10.0 wt % (2.71 mol %), MFR value is 2.5 g/10 min and the density is 0.919 g/mL;
Linear low density ethylene-octene-1 copolymer, LLDPE (2): the content of recurring units derived from octene-1 is 9.5 wt % (2.56 mol %), MFR value is 1 g/10 min and the density is 0.918 g/mL;
Linear low density ethylene-hexene-1 copolymer, LLDPE (3): the content of recurring units derived from hexene-1 is 12.1 wt % (4.39 mol %), MFR value is 2.3 g/10 min and the density is 0.917 g/mL;
Very low density ethylene-octene-1 copolymer, VLDPE: the content of recurring units derived from octene-1 is 15.3 wt % (4.3 mol %), MFR value is 1 g/10 min and the density is 0.912 g/mL;
Ethylene copolymer blend, LLDPE blend: it consists of (a) 85 wt % of a terpolymer of ethylene and butene-1 and hexene-1 having 6.5 wt % (3.45 mol %) of recurring units derived from butene-1 and 4 wt % (1.42 mol %) of recurring units derived from hexene-1, the density is 0.919 g/mL and (b) 15 wt % of terpolymer of propylene and ethylene and butene-1, wherein the recurring units derived from propylene, ethylene and butene-1 are 92.1, 2.3 and 5.6 wt %, respectively, the density is 0.90 g/mL. The blend has an MFR value of 0.7 g/10 min and density of 0.916 g/mL;
Ethylene-hexene-1 copolymer, mPE (1): the content of recurring units derived from hexene-1 is 7.0 w % (2.45 mol %), MFR value is 1 g/10 min and the density is 0.918 g/mL. The copolymer is prepared by using a metallocene catalyst;
Ethylene-hexene-1 copolymer, mPE (2): the content of recurring units derived from hexene-1 is 3.9 wt % (1.33 mol %), MFR value is 0.7 g/10 min and the density is 0.927 g/mL. The copolymer is prepared by using a metallocene catalyst.

### Examples 1-14 and Comparative Examples 1-3

A polymer blend is produced by extruding the proper components in a single screw type extruder (30 L/D screw length). Table 1 lists the polymers used and their relative amounts. Then, the thus obtained polymer blends are filmed trough a 40 mm grooved feed single screw extruder (KRC40), thus single layer blown films are produced. The films according to the present invention are produced with a blow-up ratio higher than 1.8, while the comparative films are produced with a blow-up ratio less than or equal to 1.8.

The physical and mechanical properties of the films as well as the results of the bundling test carried out on the films are reported in Table 2 and Table 3.

In comparison with the films of the comparative examples the films according to the present invention exhibit both a good balance of mechanical properties, good transparency and good sealability. Resistance of the sealed film is an indirect index of the sealability of the film. The bundling test shows that the films according to the present invention only have those main properties that make a film suitable for bundling.

TABLE 1

| | | | | | | | | | | | | | | | Comparative | | |
|---|---|---|---|---|---|---|---|---|---|---|---|---|---|---|---|---|---|
| Components | Examples | | | | | | | | | | | | | | Examples | | |
| (wt %) | 1 | 2 | 3 | 4 | 5 | 6 | 7 | 8 | 9 | 10 | 11 | 12 | 13 | 14 | 1 | 2 | 3 |
| EBA copolymer (1) | 75 | 75 | 75 | 75 | 0 | 0 | 0 | 0 | 0 | 0 | 0 | 0 | 75 | 0 | 0 | 0 | 0 |
| EBA copolymer (2) | 0 | 0 | 0 | 0 | 0 | 0 | 0 | 0 | 0 | 0 | 0 | 0 | 0 | 75 | 0 | 75 | 67 |
| EBA copolymer (3) | 0 | 0 | 0 | 0 | 0 | 0 | 75 | 75 | 0 | 0 | 0 | 0 | 0 | 0 | 0 | 0 | 0 |
| EVA copolymer (1) | 0 | 0 | 0 | 0 | 75 | 0 | 0 | 0 | 75 | 0 | 0 | 0 | 0 | 0 | 0 | 0 | 0 |
| EVA copolymer (2) | 0 | 0 | 0 | 0 | 0 | 75 | 0 | 0 | 0 | 0 | 0 | 0 | 0 | 0 | 0 | 0 | 0 |
| EMA copolymer | 0 | 0 | 0 | 0 | 0 | 0 | 0 | 0 | 0 | 75 | 0 | 75 | 0 | 0 | 0 | 0 | 0 |
| EEA copolymer | 0 | 0 | 0 | 0 | 0 | 0 | 0 | 0 | 0 | 0 | 75 | 0 | 0 | 0 | 0 | 0 | 0 |
| LDPE | 0 | 0 | 0 | 0 | 0 | 0 | 0 | 0 | 0 | 0 | 0 | 0 | 0 | 0 | 100 | 0 | 0 |
| LLDPE (1) | 0 | 0 | 0 | 0 | 0 | 0 | 0 | 0 | 0 | 0 | 0 | 0 | 0 | 25 | 0 | 25 | 0 |
| LLDPE (2) | 0 | 25 | 0 | 0 | 25 | 25 | 25 | 0 | 0 | 25 | 25 | 0 | 0 | 0 | 0 | 0 | 0 |
| LLDPE (3) | 0 | 0 | 0 | 0 | 0 | 0 | 0 | 0 | 0 | 0 | 0 | 0 | 25 | 0 | 0 | 0 | 0 |
| VLDPE | 0 | 0 | 0 | 0 | 0 | 0 | 0 | 0 | 0 | 0 | 0 | 0 | 0 | 0 | 0 | 0 | 33 |
| LLDPE blend | 25 | 0 | 0 | 0 | 0 | 0 | 0 | 25 | 25 | 0 | 0 | 25 | 0 | 0 | 0 | 0 | 0 |
| mPE (1) | 0 | 0 | 0 | 25 | 0 | 0 | 0 | 0 | 0 | 0 | 0 | 0 | 0 | 0 | 0 | 0 | 0 |
| mPE (2) | 0 | 0 | 25 | 0 | 0 | 0 | 0 | 0 | 0 | 0 | 0 | 0 | 0 | 0 | 0 | 0 | 0 |

TABLE 2

| | | Examples | | | | | | | | | |
|---|---|---|---|---|---|---|---|---|---|---|---|
| Properties of the film | | 1 | 2 | 3 | 4 | 5 | 6 | 7 | 8 | 9 | 10 |
| Average thickness, | | 60 | 60 | 70 | 75 | 70 | 70 | 60 | 65 | 70 | 65 |
| μm | | | | | | | | | | | |
| 2% secant | MD | 170 | 126 | 132 | 103 | 122 | 118 | 125 | 126 | 117 | 124 |
| tensile | TD | 201 | 142 | 162 | 110 | 131 | 123 | 127 | 133 | 123 | 130 |
| modulus, MPa | | | | | | | | | | | |

| | | | | | | | | | | |
|---|---|---|---|---|---|---|---|---|---|---|
| MD Elmendorf tear | 1.27 | 1.98 | 3.78 | 3.0 | 2.67 | 2.85 | 2.30 | 2.10 | 2.60 | 2.60 |
| resistance, N | | | | | | | | | | |
| MD/TD Elmendorf | 0.41 | 0.37 | 0.51 | 0.54 | 0.50 | 0.57 | 0.50 | 0.37 | 0.48 | 0.39 |
| tear resistance ratio | | | | | | | | | | |
| MD tensile strength at | 11.0 | 9.2 | 9.7 | 8.8 | 11.4 | 10.0 | 9.9 | 9.4 | 10.2 | 8.2 |
| 30%¹⁾, N | | | | | | | | | | |
| MD residual strength | 5.6 | 5.1 | 5.3 | 4.7 | 5.6 | 5.2 | 4.9 | 5.0 | 5.5 | 4.2 |
| at 30%, N | | | | | | | | | | |
| MD residual strength | 0.51 | 0.55 | 0.55 | 0.53 | 0.49 | 0.52 | 0.49 | 0.53 | 0.54 | 0.51 |
| at 30%/MD tensile | | | | | | | | | | |
| strength at 30% ratio | | | | | | | | | | |
| MD | 9.3 | 8.5 | 7.6 | 6.3 | 8.0 | 7.4 | 8.2 | 7.7 | 7.9 | 6.5 |
| normalized | | | | | | | | | | |
| residual | | | | | | | | | | |
| strength at | | | | | | | | | | |
| 30%, cN/μm | | | | | | | | | | |
| Dart, g | 249 | 388 | 222 | 711 | 447 | 364 | 400 | 426 | 526 | 368 |
| Haze, % | 15.5 | 12.5 | 12.4 | 12.3 | 8.4 | 9.5 | 9.8 | 9.3 | 8.0 | 12.9 |

| | |
|---|---|
| | Comparative |
| Examples | Examples |

| Properties of the film | | 11 | 12 | 13 | 14 | 1 | 2 | 3 |
|---|---|---|---|---|---|---|---|---|
| Average thickness, | | 65 | 65 | 70 | 65 | 85 | 50 | 65 |
| μm | | | | | | | | |
| 2% secant | MD | 120 | 131 | 119 | 105 | 188 | 125 | 110 |
| tensile | TD | 123 | 132 | 120 | 107 | 199 | 147 | 117 |
| modulus, MPa | | | | | | | | |

| | | | | | | | |
|---|---|---|---|---|---|---|---|
| MD Elmendorf tear | 2.70 | 3.10 | 3.28 | 2.97 | 2.80 | 1.27 | 1.98 |
| resistance, N | | | | | | | |
| MD/TD Elmendorf | 0.41 | 0.51 | 0.63 | 0.52 | 0.23 | 0.28 | 0.17 |
| tear resistance ratio | | | | | | | |
| MD tensile strength at | 8.9 | 9.4 | 9.0 | 7.6 | 13.0 | 6.1 | 11.0 |
| 30%¹⁾, N | | | | | | | |
| MD residual strength | 4.5 | 4.6 | 4.5 | 4.0 | 5.9 | 3.4 | 6 |
| at 30%, N | | | | | | | |
| MD residual strength | 0.51 | 0.49 | 0.50 | 0.53 | 0.45 | 0.56 | 0.54 |
| at 30%/MD tensile | | | | | | | |
| strength at 30% ratio | | | | | | | |
| MD | 6.9 | 7.1 | 6.4 | 6.2 | 6.9 | 6.8 | 9.2 |
| normalized | | | | | | | |
| residual | | | | | | | |
| strength at | | | | | | | |
| 30%, cN/μm | | | | | | | |
| Dart, g | 345 | 407 | 459 | 435 | 162 | 209 | 570 |
| Haze, % | 12.6 | 14.2 | 17.7 | 16.8 | 17 | 10 | 17 |

¹⁾Force required to cause the stretching of 30% of a specimen of material.

TABLE 3
Bundling test

| | Examples | | | | | | | | | |
|---|---|---|---|---|---|---|---|---|---|---|
| Properties of the film | 1 | 2 | 3 | 4 | 5 | 6 | 7 | 8 | 9 | 10 |
| Resistance of sealed | good | good | very | very | good | good | good | good | good | good |
| film portion | | | good | good | | | | | | |
| Toughness of packaged | very | good | good | good | good | good | excellent | good | excellent | excellent |
| items after 1 minute | good | | | | | | | | | |

| | |
|---|---|
| | Comparative |
| Examples | Examples |

| Properties of the film | 11 | 12 | 13 | 14 | 1 | 2 | 3 |
|---|---|---|---|---|---|---|---|
| Resistance of sealed | good | good | good | good | poor | good | good |
| film portion | | | | | | | |
| Toughness of packaged | very | excellent | good | good | good | bad | bad |
| items after 1 minute | good | | | | | | |

1. A stretchable wrap film having a value of MD tear resistance, a value of TD tear resistance, and a value of MD tensile strength at 30% comprising a polymer blend, the polymer blend comprising (percent by weight):
I) 50 to 90% of an ethylene polymer composition having an ester content, comprising a recurring unit derived from an ester selected from (1) ethylenically unsaturated organic monomer of esters of unsaturated C₃-C₂₀ monocarboxylic acids and C₁ to C₂₄ monovalent aliphatic or alicyclic alcohols, and (2) vinyl esters of saturated C₂-C₁₈ carboxylic acids, wherein the ester content ranges from 2.5 to 8 wt % based on the total weight of the ethylene polymer composition; the ethylene polymer composition having a density ranging from 0.920 to 0.94 g/mL; and
II) 10 to 50% of an ethylene-based polymer component having a density ranging from 0.9 to 0.930 g/mL and a melt flow rate up to 4 g/10 min; the ethylene-based polymer component being selected from:
i) a linear polyethylene consisting of ethylene and 0.5 to 20% by mole of a first CH₂═CHR α-olefin, where R is a hydrocarbon radical having 2-8 carbon atoms; and
ii) a polymer blend comprising (a) 80-100 parts by weight of a random polymer of ethylene with at least one second CH₂═CHR α-olefin, where R is a hydrocarbon radical having 1-10 carbon atoms, the random polymer (a containing up to 20 mol % of the second CH₂═CHR α-olefin and having a density between 0.88 and 0.945 g/mL; and (b) from 5 to 30 parts by weight of a random interpolymer of propylene with at least one third CH₂═CHR α-olefin, where R is a hydrocarbon radical having from 2 to 10 carbon atoms, and optionally with ethylene, said random interpolymer (b) containing from 60 to 98% by weight of units derived from propylene, from 2 to 40% by weight of recurring units derived from the third CH₂═CHR α-olefin, and from 0 to 10% by weight of recurring units derived from ethylene, and having a xylene-insoluble fraction a room temperature greater than 70%;
wherein the stretchable wrap film has a ratio between the value of MD tear resistance and the value of TD tear resistance over 0.3 and the value of MD tensile strength at 30% ranges between 6.5 to 15 N.

2. The film of claim 1, wherein polymer composition (I) is selected from ethylene-methyl acrylate copolymer, ethylene-ethyl acrylate copolymer, ethylene-butyl acrylate copolymer and ethylene-vinyl acetate copolymer.

3. The film of claim 1, wherein in linear polyethylene (i), the first CH₂═CHR α-olefin is selected from butene-1, hexene-1, octene-1 and 4-methyl-1-pentene.

4. The film of claim 1, wherein in polymer blend (ii), the random polymer (a) is an ethylene-butene-1 copolymer.

5. The film of claim 1, wherein in polymer blend (ii), the random interpolymer (b) is a propylene-ethylene-butene-1 terpolymer.

6. A container packaging comprising a stretchable wrap film having a value of MD tear resistance, a value of TD tear resistance and a value of MD tensile strength at 30% comprising a polymer blend, the polymer blend comprising (percent by weight):
I) 50 to 90% of an ethylene polymer composition having an ester content, comprising a recurring unit derived from an ester selected from (1) ethylenically unsaturated organic monomer of esters of unsaturated C₃-C₂₀ monocarboxylic acids and C₁ to C ₂₄ monovalent aliphatic or alicyclic alcohols, and (2) vinyl esters of saturated C₂-C₁₈ carboxylic acids, wherein the ester content ranges from 2.5 to 8 wt % based on the total weight of the ethylene polymer composition, the ethylene polymer composition having a density ranging from 0.920 to 0.94 g/mL: and
II) 10 to 50% of an ethylene-based polymer component having a density ranging from 0.9 to 0.930 g/mL and a melt flow rate up to 4 g/10 min; the ethylene-based polymer component being selected from:
i) a linear polyethylene consisting of ethylene and 0.5 to 20% by mole of a first CH₂═CHR α-olefin, where R is a hydrocarbon radical having 2-8 carbon atoms: and
ii) a polymer blend comprising (a) 80-100 parts by weight of a random polymer of ethylene with at least one second CH₂═CHR α-olefin, where R is a hydrocarbon radical having 1-10 carbon atoms, the random polymer (a) containing up to 20 mol % of the second CH₂═CHR α-olefin and having a density between 0.88 and 0.945 g/mL; and (b) from 5 to 30 parts by weight of a random interpolymer of propylene with at least one third CH₂═CHR α-olefin, where R is a hydrocarbon radical having from 2 to 10 carbon atoms, and optionally with ethylene, said random interpolymer (b) containing from 60 to 98% by weight of units derived from propylene, from 2 to 40% by weight of recurring units derived from the third CH₂═CHR α-olefin, and from 0 to 10% by weight of recurring units derived from ethylene, and having a xylene-insoluble fraction a room temperature greater than 70%:
wherein the stretchable wrap film has a ratio between the value of MD tear resistance and the value of TD tear resistance over 0.3 and the value of MD tensile strength at 30% ranges between 6.5 to 15 N.
